(19) United States
(12) Patent Application Publication
(10) Pub. No.: US 2011/0299934 A1
(43) Pub. Date: Dec. 8, 2011

(54) SYSTEM AND METHOD FOR PLUGGING A BROKEN FLUID DELIVERY PIPE

(76) Inventor: Antonio S. Romero, Albuquerque, NM (US)

(21) Appl. No.: 13/155,626

(22) Filed: Jun. 8, 2011

Related U.S. Application Data
(60) Provisional application No. 61/352,481, filed on Jun. 8, 2010.

(51) Int. Cl. F16L 55/18

(52) U.S. Cl. 405/184.1

(57) ABSTRACT

A tool, system and methods for plugging broken fluid delivery pipe are disclosed. A plugging tool can be used to plug a fluid leak in a broken pipe. A relief pipe and associated relief valve assembly can be installed on the sides of the broken pipe. Before plugging, the relief valves can be opened to relieve back pressure created during plugging operation. The relief piping can be installed on the side of a broken pipe using a diamond blade edging technique followed by threading. The tapered portion of the tool facilitates the plugging process and snuggly fit the tool into the broken pipe. A fluid storage mechanism can be provided for storing fluid obtained from the plugged pipe via relief pipes under the control of associated relief valves.

### CROSS-REFERENCE TO PROVISIONAL APPLICATION

This application claims priority to U.S. Provisional Patent Application Ser. No. 61/352481, which was filed on Jun. 8, 2010, the disclosure of which is incorporated herein by reference in its entirety.

### TECHNICAL FIELD

Embodiments are generally related to broken fluid delivery pipe plugging and environmental remediation. Embodiments also relate to the field of fractured pipes delivering fluid under high pressure in an ocean environment. Embodiments additionally relate to tool, techniques and systems for plugging broken fluid delivery pipe.

### BACKGROUND OF THE INVENTION

In the Gulf of Mexico, a deep-sea oil well was leaking tens of thousands of gallons of oil per day into the sea, from broken oil pipe five thousand feet under the water. It was determined that a fail-safe blow out valve failed, so the flow of oil and gas was virtually unimpeded. Attempts were made to stem the escape of oil into the environment, but most failed due to technical problems.

A first attempt, referred to as ‘top hat’, is essentially a funnel and pipe method. The ‘top hat’ system includes the fractured pipe, the high velocity oil and gasses escaping through the fractures, and high water pressure at 1.5 kilometers below the sea surface and the collection vessel (i.e., hence a “top hat”). A ‘top hat’ or inverted funnel is placed over the section of the fractured pipe from which oil is escaping. The skirt of the ‘top hat’ could not be sealed due to technical difficulties in forming any kind of seal to either the seabed or any other convenient structure. Apparently, it was believed that the oil, being less dense than water, would gather in the ‘top hat’ whilst displacing water from beneath the bottom edge of the ‘top hat’. The idea was apparently to pump the oil out of the top hat through a pipe fitted to an aperture in the roof of the ‘top hat’. The method failed.

A second method, referred to as ‘top kill’ was fraught with technical difficulties as a result of forcing debris down the oil well in an attempt to create a ‘traffic jam’ of material. The idea was to slow the flow of material from the well sufficiently to pump in a cap of concrete. The method failed.

A very high cost in environmental and economic damage was expected and was realized for the entire Gulf region as well as the United States and Mexican economies as a result of the broken oil pipe. A tragedy that should have been minimized and stopped within days took too long to stop. In an effort to address the foregoing difficulties, it is believed that the ability to effectively plug broken pipes carrying fluid under high pressure, such as the oil pipe discussed in detail herein, is needed. The present invention can address many of the problems experienced with broken pipes. It is believed that the implementation of an improved method and system as disclosed herein can stop, plug and/or block, high pressure piping that becomes broken and leaks fluid under high pressure.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide a broken fluid delivery pipe plugging tool, method and system.

It is another aspect of the disclosed embodiments to provide a tool, method and system for the plugging fractured pipes delivering fluid under high pressure.

The aforementioned aspects and other objectives and advantages can now be achieved as described herein. A tool, a system and methods for plugging broken fluid delivery pipe are disclosed. A plugging tool can be utilized to plug a broken pipe that is leaking fluid under pressure. A relief valve assembly can be utilized for installing one or more relief valves into the sides of the broken pipe. Before plugging, the relief valves can be opened to relieve backpressure created during plugging operations. In some situations the relief valves can be installed using integrated diamond blade edging technique followed by threading. In ocean and deep sea drilling applications, fluid storage mechanism such as fluid tankers can be provided for storing the fluid from one or more relief valves.

The disclosed embodiments can be utilized to plug the leak in broken pipe carrying fluid under pressure. The plugging tool has a tapered portion for closing off the broken pipe. When closure by the tool occurs, pressure is increased at the broken pipe's opening. The pressure can prevent the insertion of the tool or installation of the tool as plug. Relief valves secured at or integrated within the sides of the broken pipe can be opened before the tool is inserted into the broken pipe.

It is another feature that relief valves installed at the sides of a broken pipe leaking under high pressure can be used to relieve back pressure created once the tool is inserted and plugs the broken pipe. Several relief valves can be installed on the broken pipe as needed to relieve pressure and capture fluid. The relief valve or pipe assembly can be drilled or installed into the sides of a broken pipe using integrated diamond blade edging followed by threading that can allow a relief piping and associated valve to be screwed into and be secured to the sides of the broken pipe.

### BRIEF DESCRIPTION OF THE DRAWINGS

The accompanying figures, in which like reference numerals refer to identical or functionally similar elements throughout the separate views and which are incorporated in and form a part of the specification, further illustrate the disclosed embodiments and, together with the detailed description of the invention, serve to explain principles of various features of the present invention.

FIG. 1 illustrates a simplified schematic diagram of a broken pipe system delivering high pressure fluid to a platform, in accordance with features of the invention;

FIG. 2 illustrates a schematic diagram of a tool utilized for plugging a broken pipe delivering fluid at high pressure, in accordance with features of the invention;

FIG. 3 illustrates a sectional view of a tool taken along the line A-A of FIG. 2, in accordance with features of the invention;

FIG. 4 illustrates a schematic diagram of a system for plugging a broken fluid delivery pipe, in accordance with features of the invention;

FIG. 5A illustrates a schematic diagram of a relief valve assembly utilized for installing a relief valve into a broken pipe before installation, in accordance with features of the invention;

FIG. 5B illustrates a schematic diagram of relief valves before and after installation, in accordance with features of the invention;

FIG. 6A illustrates a schematic diagram of a relief valve assembly utilized for installing a relief valve into a broken pipe before installation, in accordance with features of the invention;

FIG. 6B illustrates a schematic diagram of a relief valve assembly utilized for installing a relief valve into a broken pipe after installation, in accordance with features of the invention;

FIG. 7 illustrates a schematic diagram of a relief valve assembly utilized for installing a relief valve into a broken pipe before and after installation, in accordance with features of the invention;

FIG. 8 illustrates a schematic diagram of a system showing a tool utilized before plugging a broken fluid delivery pipe, in accordance with features of the invention;

FIG. 9 illustrates a schematic diagram of a system showing a tool utilized after plugging a broken fluid delivery pipe, in accordance with features of the invention;

FIG. 10A illustrates a high level flow chart depicting the process of plugging a broken fluid delivery pipe, in accordance with features of the invention; and

FIG. 10B illustrates a high level flow chart depicting the process of installing a relief valve into a broken pipe, in accordance with features of the invention.

### DETAILED DESCRIPTION

The particular values and configurations discussed in these non-limiting examples can be varied and are cited merely to illustrate at least one embodiment and are not intended to limit the scope thereof.

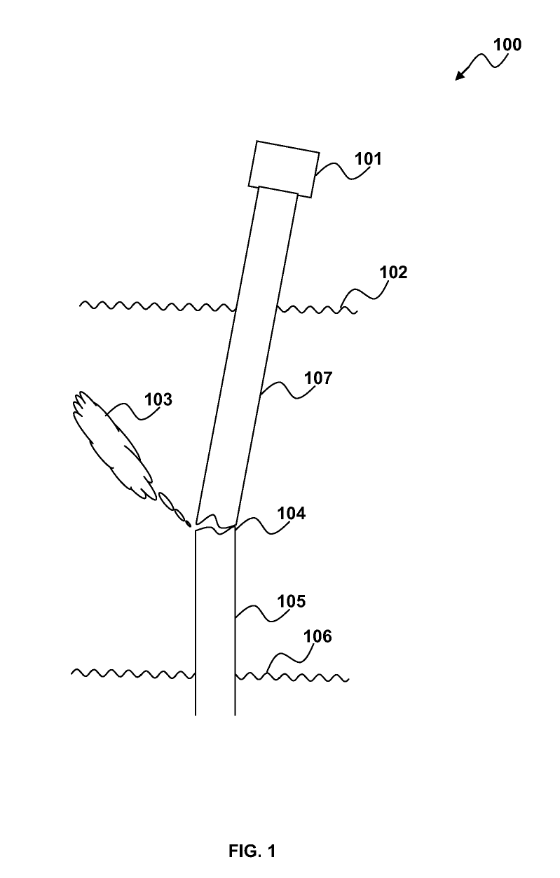

FIG. 1 illustrates a simplified schematic diagram of a broken fluid pipe 100. Without limiting application of the present invention, pipe 107 can be viewed as delivering fluid under pressure, for example oil to a platform 101. In the example, the pipe 107 has become broken, also referred as broken portion 104 underneath a water surface 102 near the bottom of a seabed 106, and the broken pipe 105 leaks high-pressured fluid into the water representing a sea or ocean. The reference numeral 103 generally refers a leak in the broken portion 104.

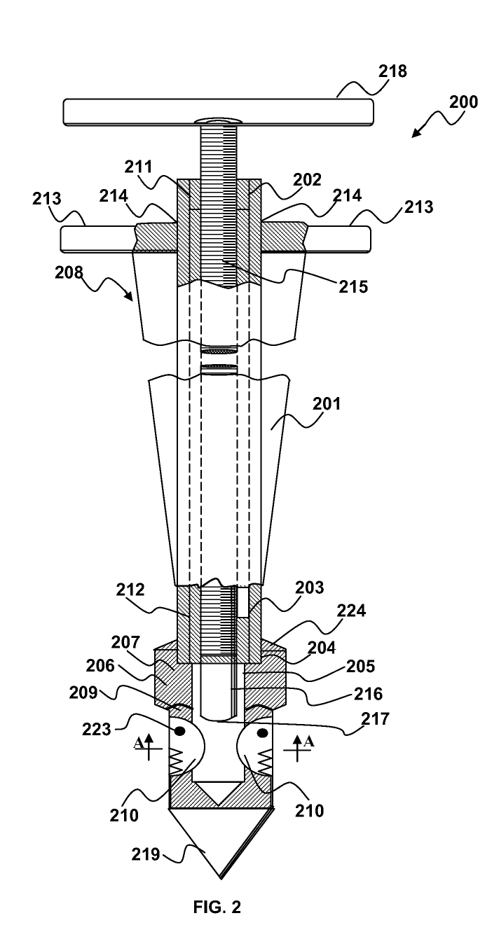

FIG. 2 illustrates a schematic diagram of a tool 200 that can be utilized for plugging a broken pipe delivering fluid at high pressure, although it should be appreciated that the tool 200 can also be used to plug pipe that is not under fluid pressure. The tool 200 includes a tubular shank also referred as tubular sleeve 201 having upper and lower ends 202 and 203 respectively. The lower end 203 of the tubular shank 201 is secured in a counterbore 204 defined at the upper end of an upstanding bore 205 formed in a lower terminal end head piece 206. The lower end 203 is secured in the counterbore 204 in any convenient manner such as by welding 224.

The head piece 206 defines an upstanding generally cylindrical body 207 in which the upstanding bore 205 and counterbore 204 are formed. The body 207 further includes a transverse passage 209 into which the lower end of the bore opens and in whose opposite ends a plurality of jaw members 210 are pivotally supported as at 223.

The upper end 202 of the tubular sleeve 201 has an internally threaded upper sleeve portion 211 secured therein and the lower end 203 of the tubular sleeve 201 has a similar internally threaded lower sleeve portion 212 secured therein, the internally threaded lower sleeve portion 212 also being seated in the inner end of the counterbore 204.

The upper end of the tubular sleeve or the tubular shank 201 can include a pair of diametrically oppositely and outwardly projecting hand grips 213 secured to the outer surface portions of the tubular shank 201 in any convenient manner such as by welding 214. A threaded shank member 215 is threadedly passed through the internally threaded upper and lower sleeves 211/212 and includes a diametrically reduced lower end portion 216 whose lower terminal end can be rounded as at 217. Further, the upper end of the shaft member 215 can be provided with a diametric handle 218.

The tool 200 can be inserted and then fit snuggly into a broken pipe 105 where the tool 200 can be tapered as at 208. Once the conical lower end 219 of the tool 200 is in place into the broken pipe 105, the shank member 201 can be rotated into the internally threaded sleeve 211 of tubular shank 201 causing the jaw members 210 to swing out into engagement with inside surface of the broken pipe 105.

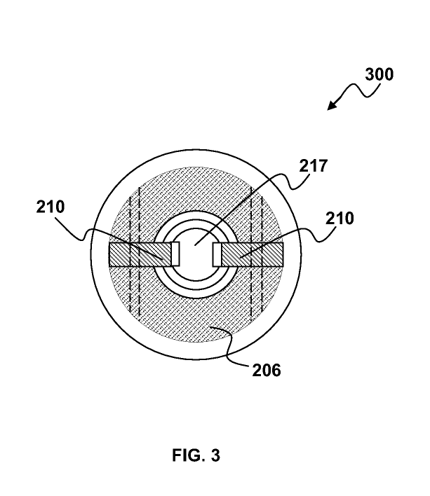

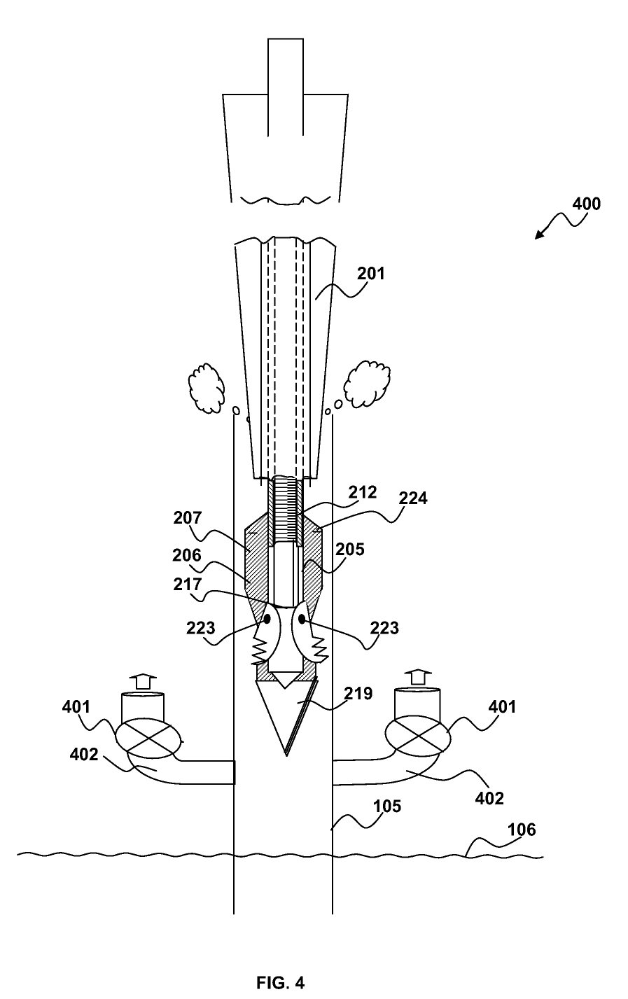

FIG. 3 illustrates a sectional view of a tool taken along the line A-A of FIG. 2, referred by the reference numeral 300, in accordance with features of the invention. FIG. 4 illustrates a schematic diagram of a system 400 for plugging broken fluid delivery pipe, in accordance with features of the invention. The tool 200 is being inserted into the broken pipe 105. The tapered portion 208 of the tool 200 is shown closing off the broken pipe. When closure by the tool occurs, pressure is increased within the broken pipe 105. The pressure can often prevent insertion of the tool 200 as plug. In order to relieve pressure so that the tool 200 can be properly inserted, relief valves 401 and tubing 402 can be secured at the sides of the broken pipe 105 before insertion of the tool 200. Before the tool 200 is inserted into the broken pipe 105, the relief valves 401 can be opened to relieve back pressure that can be created once the tool 200 is inserted and plugs to the broken pipe 105. It can be appreciated that the relief pipes 401 can be connected to tubing 402 that can carry the fluid to a useful destination for example oil tanker. It should also be appreciated that several relief valves 401 can be formed on the broken pipe 105 as needed to relieve pressure and capture fluid.

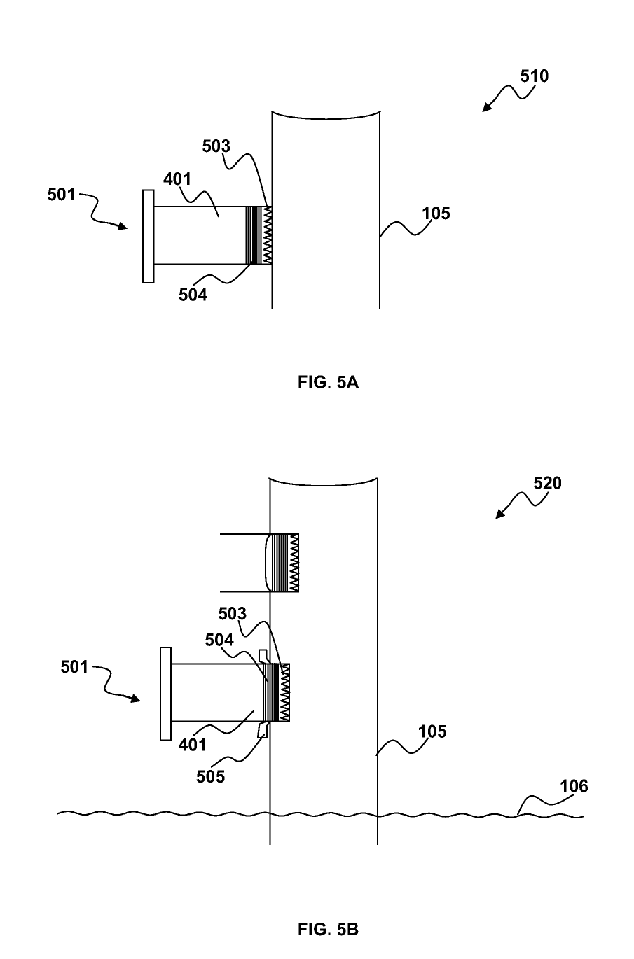

FIG. 5A and FIG. 5B illustrates a schematic diagram of a relief valve assembly utilized for installing a relief valve into a broken pipe before and after installation respectively, referred by the reference numerals 510 and 520 respectively, in accordance with disclosed embodiments. Depending on the material that a broken pipe is made of, the relief valve or pipe assembly 501 can be drilled or installed into the broken pipe 105 using various tools, for example an integrated diamond blade edging technique can be applied to the side of a the broken pipe 105 followed by threading that can screw a relief pipe into the side of the broken pipe 105 and be secured thereto. The relief valve assembly 501 can include a threader 504, a circular bit edge 503 and a stopper 505. The circular bit edge 503 can include a diamond blade material for cutting the broken pipe 105 so as to insert the relief valve 401 into the broken pipe 105.

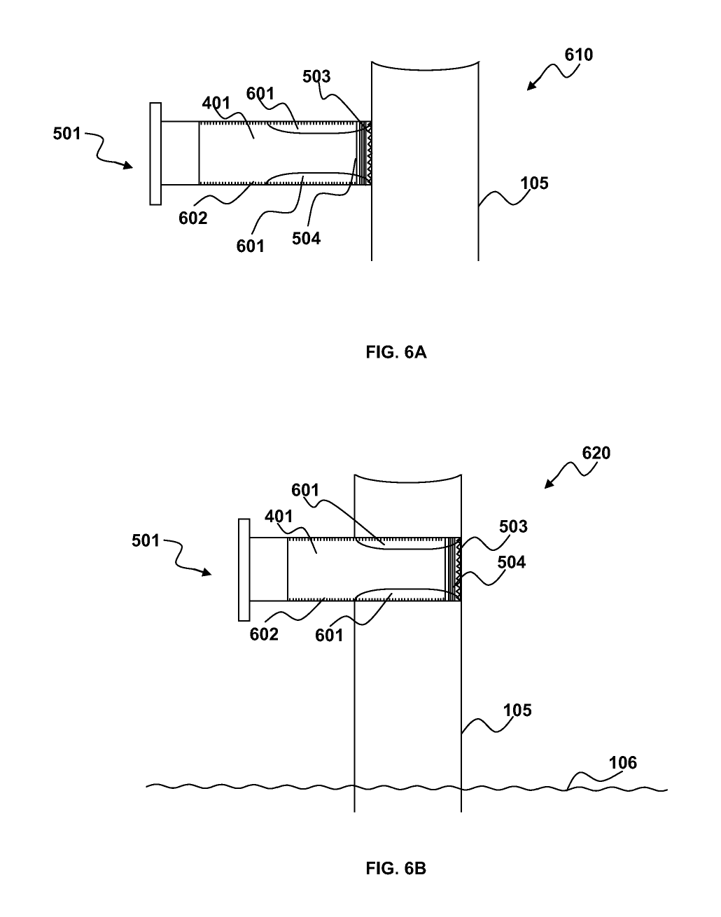

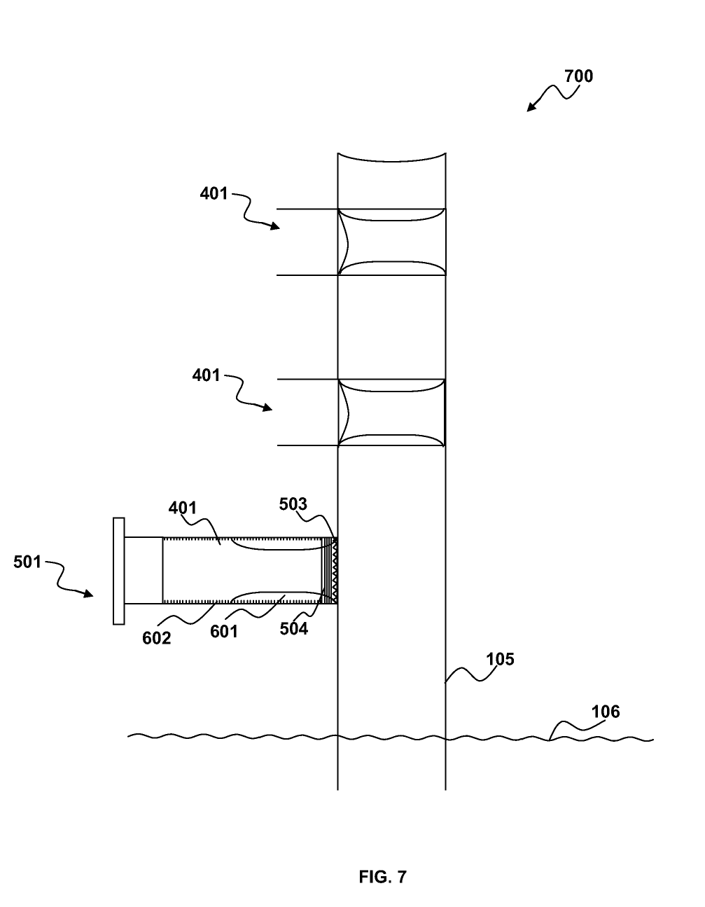

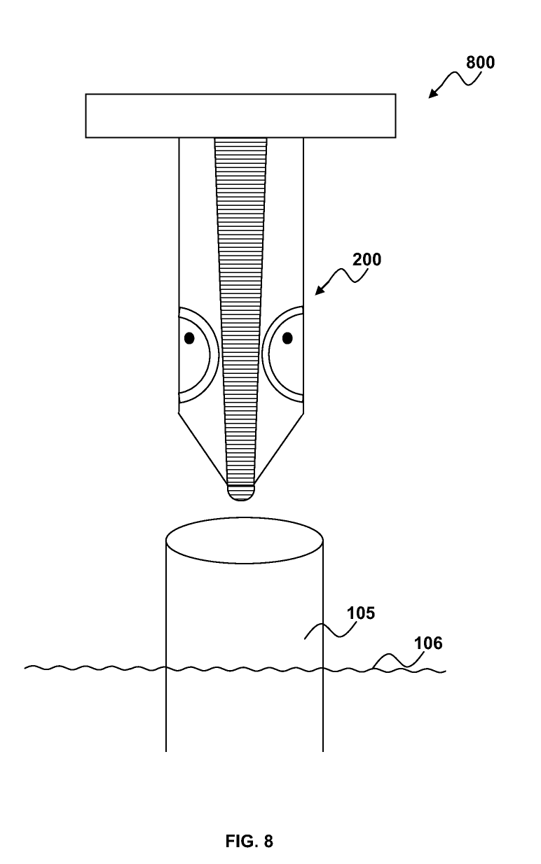

FIG. 6A and FIG. 6B illustrates a schematic diagram of the relief valve assembly that can be utilized for installing a relief valve into a broken pipe before installation and after installation respectively, referred by the reference numerals 610 and 620 respectively, in accordance with another embodiment. The relief valve assembly 501 can further include a threaded pipe 602 and pipe opening 601. Note that in FIG. 5A, FIG. 5B, FIG. 6A, FIG. 6B, FIG. 7 and FIG. 8, identical or similar parts or elements are generally indicated by identical reference numerals.

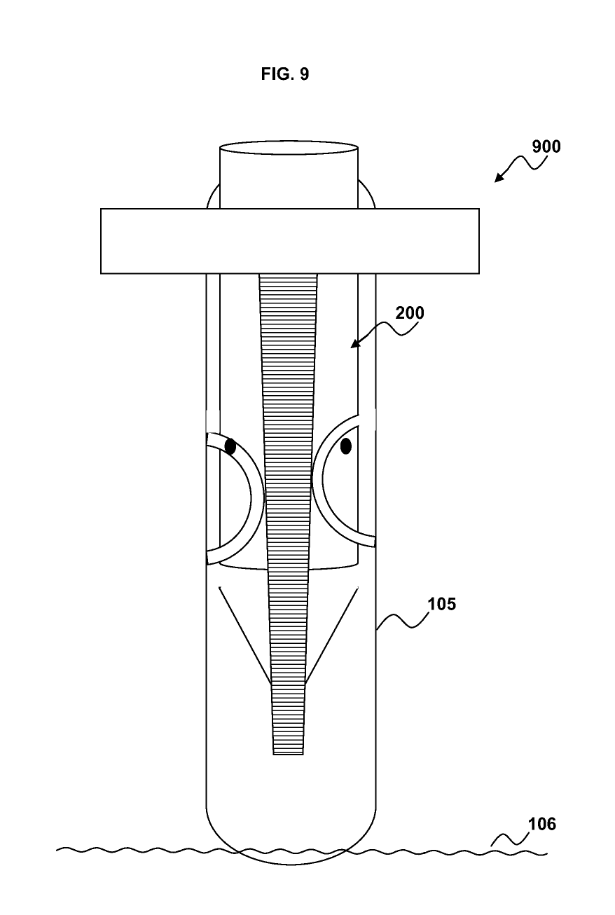

FIG. 7 illustrates a schematic diagram of a relief valve assembly that can be utilized for installing a relief valve into a broken pipe before and after installation, referred by the reference numeral 700, in accordance with another embodiment. During the plugging process, the pipe openings 602 allow the back pressure and fluid to the relief valve 401. FIG. 8 and FIG. 9 illustrate a schematic diagram of a system showing a tool utilized before and after plugging a broken fluid delivery pipe respectively referred by the reference numerals 800 and 900 respectively, in accordance with disclosed embodiments.

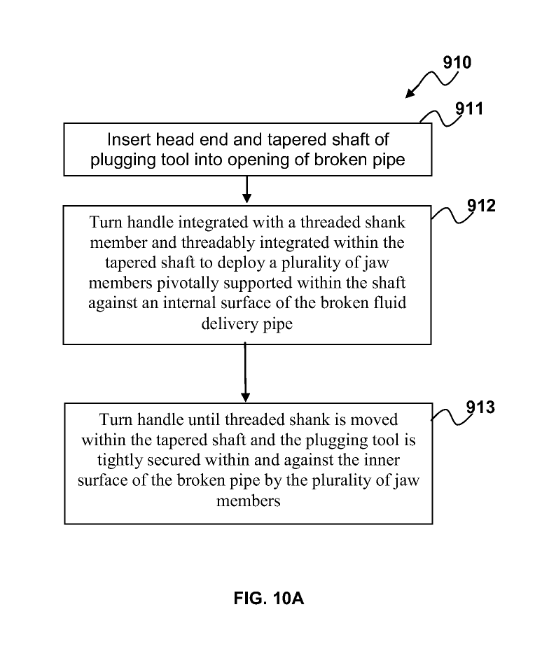

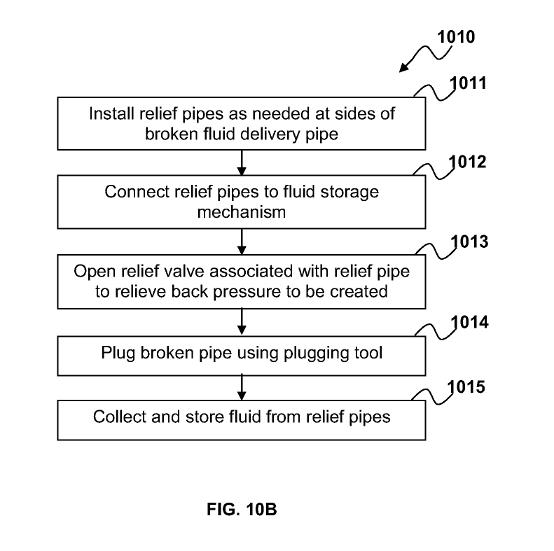

FIG. 10A illustrates a high level flow chart 910 depicting the process of plugging a broken fluid delivery pipe, in accordance with features of the present invention. A head end and tapered shaft of a plugging tool can be inserted into the opening of broken fluid delivery pipe as depicted at block 911. As illustrated at block 912, a handle integrated with a threaded shank member threadably integrated within the tapered shaft can be turned to deploy a plurality of jaw members pivotally supported within the shaft the internal surface of the broken fluid delivery pipe. The threaded shank is moved within the tapered shaft by turning of the handle until the plugging tool is tightly secured within and against the inner surface of the broken pipe by the plurality of jaw members, as indicated at block 913.

FIG. 10B illustrates a high level flow chart 1010 depicting the process of plugging a broken pipe under fluid pressure when relief valves is installed into the side of a broken pipe, in accordance with the disclosed embodiments. Relief pipes are can be installed as needed at sides of a broken fluid delivery pipe prior to plugging it with a plugging tool, as shown in step 1011. The relief pipe can be connected to a fluid storage mechanism, as shown in step 1012. Relief valves associated with relief pipe can be opened to relieve back pressure that may be created during plugging of broken pipe with a plugging tool, as shown in step 1013. Then, as depicted at block 1014, the broken pipe is plugged using a plugging tool (as discussed with respect to FIG. 10A). Finally, fluid from the broken pipe, now plugged, can be collected by relief pipes and stored.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for plugging a broken pipe delivering a fluid at high pressure, comprising:
a plugging tool including a threaded shank member threadably movable within a tapered shaft, said tapered shaft insertable within a end of a broken pipe under fluid pressure and retained within the broken pipe at the end of a broken pipe by a plurality of jaw members pivotably supported within the tapered shaft of the plugging tool and firmly deployed against a inner surface of the broken pipe;
at least one relief pipe including a valve assembly installed on a side of the broken pipe; and
fluid storage coupled to the relief pipe for storing fluid obtained from the broken pipe once the broken pipe is plugged by the plugging tool.

2. The system of claim 1 wherein said at least one relief valve controllably relieves back pressure created in the broken pipe during plugging and after plugging.

3. The system of claim 1 wherein said relief pipe is installed using a diamond blade edging followed by threading.

4. A method of plugging a broken pipe that is under fluid pressure, comprising:
inserting a plugging tool including a head end and tapered shaft into an opening of the broken pipe;
turning a handle integrated with a threaded shank member threadably integrated within the tapered shaft of the plugging tool to deploy a plurality of jaw members pivotably supported within the tapered shaft against an inner surface of the broken pipe;
wherein the threaded shank is moved within the tapered shaft by turning the handle until the plugging tool is tightly secured within the broken pipe and against the inner surface of the broken pipe by the plurality of jaw members.

5. A method of plugging a broken pipe that is under fluid pressure, comprising:
installing at least one relief pipe on a side of the broken pipe prior to plugging the broken pipe with a plugging tool;
connecting the at least one relief pipe to a fluid storage system;
open a relief valve associated with the at least one relief pipe prior to plugging the broken pipe to relieve back pressure created during plugging of the broken pipe;
plug the broken pipe with a plugging tool including a head end, a tapered shaft, a handle integrated with a threaded shank member threadably integrated within the tapered shaft and a plurality of jaw members pivotably supported within the tapered shaft, where the plugging tool is secured within the broken pipe by turning the handle integrated with the threaded shank member that is threadably integrated within the tapered shaft of the plugging tool to deploy the plurality of jaw members pivotably supported within the tapered shaft against an inner surface of the broken pipe; and
collecting fluid from the broken pipe that is plugged by the plugging tool.
